(19) United States
(12) Patent Application Publication
(10) Pub. No.: US 2003/0104866 A1
(43) Pub. Date: Jun. 5, 2003

(54) Electronic game unit with removable processor

(75) Inventors: James A. Campo, Brunswick, OH (US); John E. Gallagher JR., Lakewood, OH (US); Michael A. Singh, Lakewood, OH (US)

Correspondence Address: Jay F. Moldovanyi, Esq., Fay, Sharpe, Fagan, Minnich & McKee, LLP, 7th Floor, 1100 Superior Avenue, Cleveland, OH, 44114-2518, US

(73) Assignee: Arrow International, Inc.

(21) Appl. No.: 10/004,915

(22) Filed: Dec. 5, 2001

(51) Int. Cl. A63F 13/00

(52) U.S. Cl. 463/42; 463/46

(57) ABSTRACT

An electronic gaming system (10) including a master station (12) connected to one or more electronic remote gaming units (14) in a logical network. Each electronic remote gaming unit (14) includes a connection interface (26) for receiving a plug-in processor module (28) and a plug-in communication module (30). The plug-in processor module (28) includes a main processor (32) for running a gaming program which enables the remote gaming unit (14) to provide game play to a player. The main processor (32) can also control the operation of the remote gaming unit (14) and control communications with other gaming units (12, 14) via the communication module (30). The communication module (30) includes wireless communications hardware (46) or hard-wired communications hardware (48) for communicating with the other gaming units (14) in the logical network. The gaming system also includes false bingo deterrent means (68) for inhibiting voice communication from the remote gaming unit (14) to the master station (12) for broadcast to the other players when the remote gaming unit (14) has not scored a bingo.

### BACKGROUND OF THE INVENTION

The present invention relates to a gaming system, and more particularly to an electronic gaming system including a remote electronic gaming unit with plug-in processor and communication modules which is connected to a master station in a logical network.

Electronic gaming systems which enable several people to play a game simultaneously are known. One example of such a system for use in playing Bingo includes an electronic central master station connected to one or more remote electronic gaming units. The remote gaming units typically include input/output (I/O) devices such as a display and a keyboard.

Players purchase one or more Bingo game cards, either in paper or electronic form, before the game begins. The game cards include a row of letters spelling BINGO and a column of different numbers, typically five, listed below each letter. Each column of numbers are taken from a different range of numbers corresponding to only that column. For example, the five numbers appearing below B are taken from the range of numbers such as 1 to 14, those appearing below I are taken from a different range of numbers such as 15 to 30, etc. Each card typically includes a different permutation of all the available numbers.

The master station generates random Bingo numbers and associated letters from the set of numbers used in the game, commonly referred to as “balls”, each including a letter and number combination. Each number or call is conveyed, in turn, to the players at the remote gaming units. The players use the remote gaming units to mark, or “daub”, each called number listed on their game cards. One or more win patterns, common for all players, are selected before the game begins. The first player to complete the win pattern on at least one card with called numbers scores a Bingo and wins the game. Players typically call out “Bingo” when they believe they have won, and a verification process follows.

Typical electronic remote gaming units require a processor, called the main processor, for running the game program and controlling the operation of the remote gaming unit during game play. The main processor in conventional remote gaming units is typically a resident processor which is integrated into conventional electronic remote gaming units on a full-time basis, usually for the life of the gaming unit. Although a resident processor can be removed from a gaming unit, for example if the processor fails, typically the game unit housing must be opened and the task performed by a technician possessing specialized skills, making processor upgrades difficult and costly. It is desirable to simplify processor upgrades without requiring significant modifications to the remote gaming unit. The provision of a removable processor card enables the development of a range of products with varying features, e.g., more memory capacity for a large Bingo game played in a big hall.

Remote gaming units enable players to be distributed at different locations during game play. For example, some players may be located in a separate smoking area. It is desirable to alert all players, at all locations that a player has won while deterring false bingos.

Accordingly, it has been considered desirable to develop a new and improved electronic game unit which would overcome the foregoing difficulties and meet the above-stated needs while providing better and more advantageous results.

### SUMMARY OF THE INVENTION

According to one embodiment of the present invention, an electronic gaming system is provided.

More particularly, in accordance with this aspect of the invention, the electronic gaming system comprises a dumb electronic gaming unit requiring a processor for operation during game play, the dumb electronic gaming unit having at least one I/O device. A processor module is removably connected to the dumb electronic gaming unit. The processor module includes a processor for controlling the operation of the dumb electronic gaming unit and running a game play program during game play.

According to another aspect of the present invention, an electronic gaming system is provided including a plurality of gaming units connected together in a logical network for providing game play to one or more players.

More particularly in accordance with this aspect of the invention, the electronic gaming system comprises a remote electronic gaming unit for use by a player during game play. A plug-in communications module is removably connected to the remote electronic gaming unit. The communications module includes communication hardware for providing a communications link between the remote electronic gaming unit and another gaming unit in the logical network.

In accordance with still another aspect of the present invention, an electronic bingo gaming system which provides game play to a user is provided.

More particularly in accordance with this aspect of the invention, the electronic bingo gaming system comprises a master gaming unit and a remote electronic gaming unit spaced apart from the master gaming unit. The remote electronic gaming unit has a microphone for providing voice communication with the master unit to indicate the remote electronic gaming unit has scored a bingo. A speaker is connected to the master unit for broadcasting the voice communication when the remote gaming unit has scored a bingo.

In accordance with a further aspect of the present invention, an electronic gaming system is provided.

More particularly in accordance with this aspect of the invention, the electronic gaming system comprises a master unit and a plurality of handheld units spaced away from the master unit. Each handheld unit comprises a housing, an I/O device held in the housing and a connector. A plurality of plug-in processor modules are provided, one for each of the plurality of handheld units. Each processor comprises a connector adapted to mate with the connector of a respective one of the plurality of handheld units. Each of the plurality of handheld units cannot run a game play program without a respective one of the plurality of processor modules.

### BRIEF DESCRIPTION OF THE DRAWINGS

The invention may take form in certain components and structures, preferred embodiments of which will be illustrated in the accompanying drawings wherein:

FIG. 1 is a block diagram illustrating the gaming system in accordance with the present invention;

FIG. 2 is front view of the electronic remote gaming unit in accordance with the present invention;

FIG. 3 side sectional view of the electronic remote gaming unit shown in FIG. 2;

FIG. 4A is a top plan view of the electronic remote gaming unit shown in FIG. 2 without the plug-in modules connected;

FIG. 4B is a top plan view of an electronic remote gaming unit according to another embodiment of the present invention without its plug-in modules connected;

FIG. 5 is block diagram of the electronic remote gaming unit, the plug-in processor module and plug-in communications module in accordance with the present invention;

FIG. 6 is an exploded perspective view of a plug-in processor module having an optional memory module connector in accordance with another embodiment of the present invention; and

FIG. 7 is an exploded perspective view of a communication module in accordance with the present invention.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The operation of the gaming system of the present invention shall be described in further detail below using the game of Bingo as an example of the type of game played. However, it should be appreciated that the gaming system is applicable to any other suitable known game including but not limited to Keno and the like.

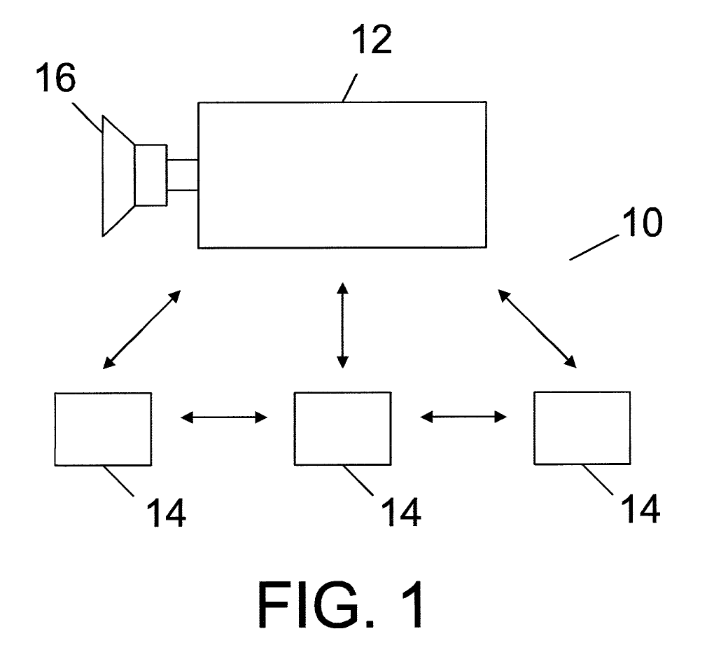

Referring now to FIG. 1 a gaming system, illustrated generally at 10, includes a master station 12 and one or more remote gaming units 14 communicating in a logical network. The logical network can include any known manner of communications linking the remote gaming units 14 and master station such as hard-wired link, a phone line modem or an RF link as described in further detail below.

A speaker 16 is operatively connected to the master station 12 as shall be described in further detail below. Each game player uses a corresponding remote gaming unit 14 to participate in game play. The players preferably play the game simultaneously, competing against each other to win, although it is contemplated that a single player may play alone by playing against or with the aid of a computer.

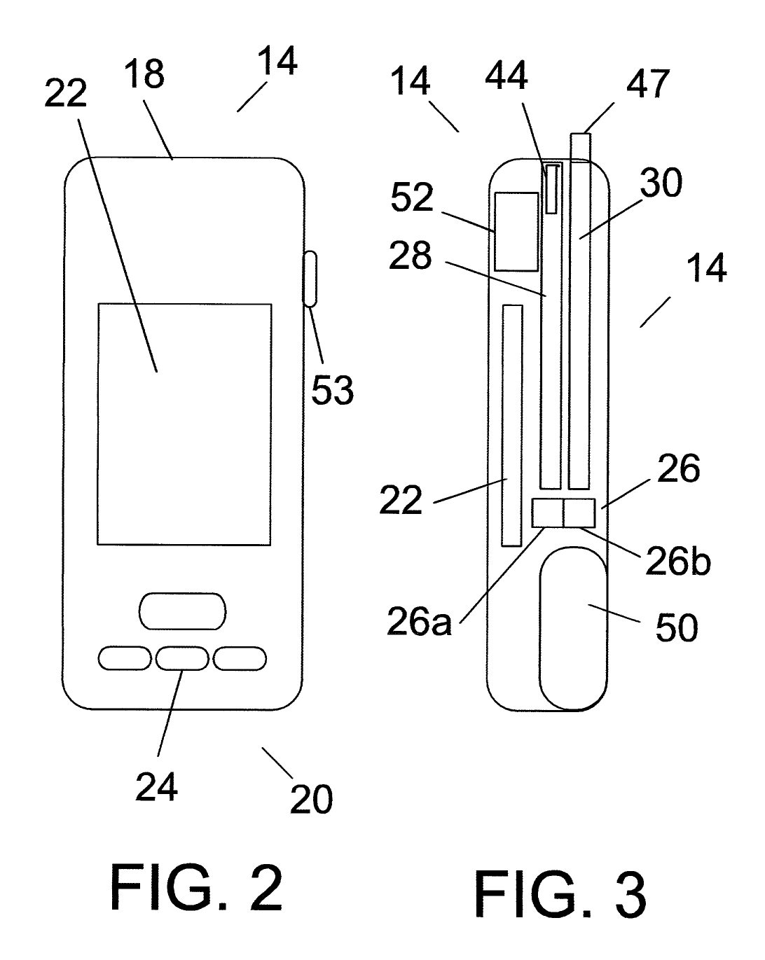

Typically the plurality of remote gaming units 14 used in the gaming system are similar and therefore only one shall be described in detail. However, the remote gaming units 14 may include different optional components as described in further detail below. Referring now to FIGS. 2-5, the remote gaming unit 14, includes a housing 18. The housing 18 can be small enough to be handheld, however a larger housing, suitable for resting on a tabletop may also be used.

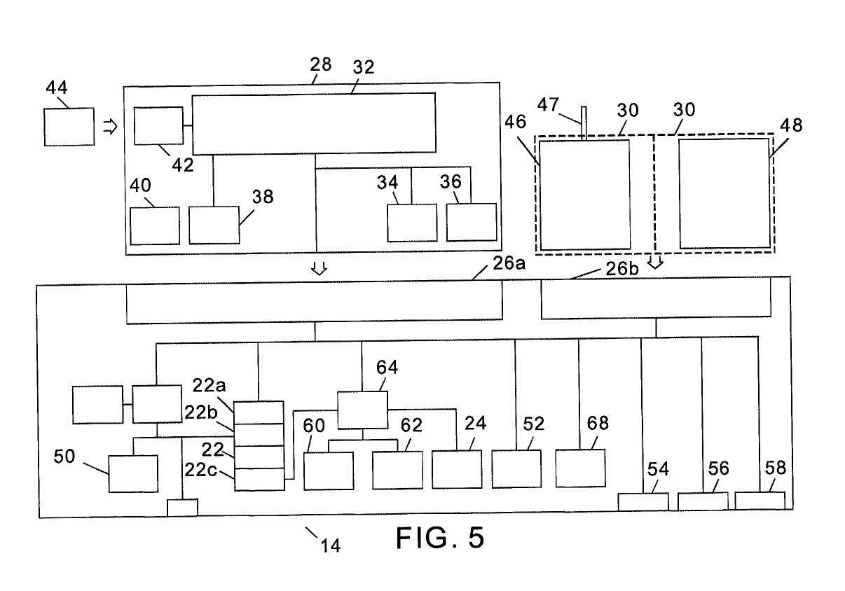

The gaming unit 14 also includes one or more input/output devices 20, including but not limited to a display 22, input keys 24, and other devices which will be described in further detail below. The display 22 can include known components including a display controller 22a, a backlight 22b, and an optional touch panel 22c performing as input keys 24, as shown in FIG. 5.

The display 22 can be a TFT, LCD or LED display, or any other suitable known display for displaying gaming information. Examples of gaming information available for display include, but are not limited to: bingo card faces, card serial numbers uniquely identifying the cards the player has in play, the game number uniquely identifying the current game in progress, the color of the current card being viewed (which identifies the set of game cards being played by the gaming system 10), the current ball called, the last ball called, the number of balls needed to win the current game for the card or cards being viewed, and the final ball number needed to win when only one more is needed for a particular card in play.

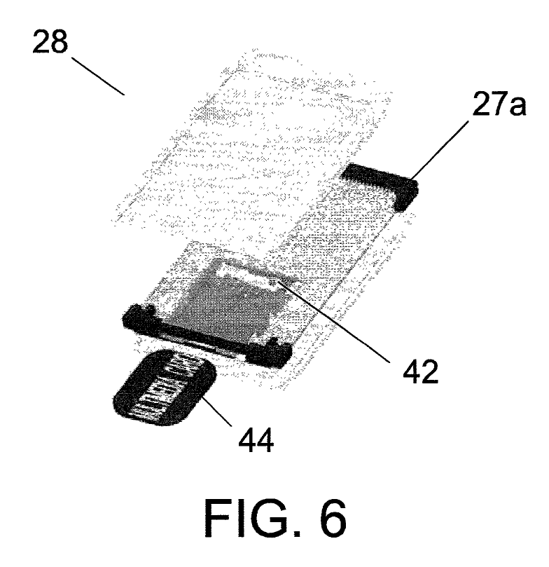

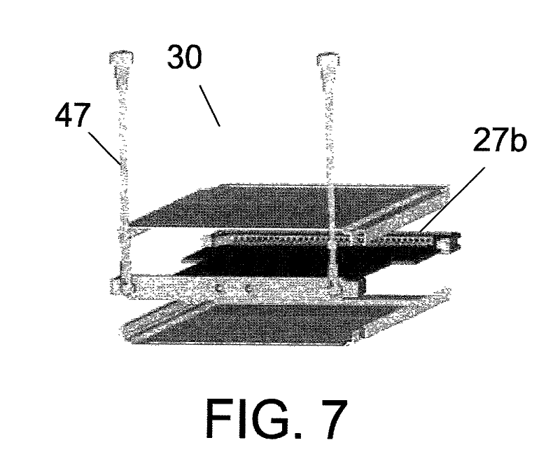

The remote gaming unit 14 of the invention includes a connector interface 26 including a connector 26a for connecting a plug-in processor module 28 to the gaming unit. The connector 26a is electrically connected to the remote gaming unit I/O devices 20. The connector interface 26 also includes a connector 26b for connecting a plug-in communications module 30, described in further detail below, to the gaming unit 14. The connectors 26a and 26b are preferably a PCMCIA connectors for mating with complementary shaped connectors 27a (FIG. 6) on the processor module 28 and complementary shaped connectors 27b (FIG. 7) on the communication module 30, although any other suitable known connectors can be used.

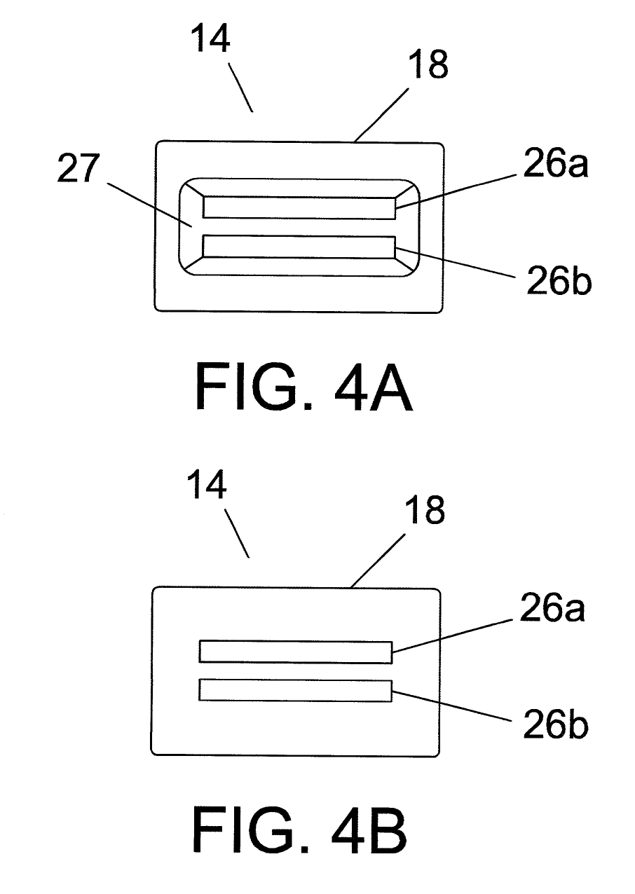

With reference now to FIG. 4A, the housing 18 includes a bay 27 for receiving the plug-in modules 28 and 30 when they are connected to the connectors 26a and 26b which are disposed in the bay. Alternatively, a separate bay 27 (not illustrated) having a corresponding connector 26a, 26b can be used for each module 28 and 30. The plug-in processor module 28 and communications module 30 can be connected to the remote gaming unit 14, and disconnected therefrom, either without opening the housing 18 or through an access door. An unskilled person such as the player or a person in charge of gaming operations can quickly and easily connect the modules 28 and 30 to the remote gaming unit 14. Alternatively, the connectors 26a, 26b can be external connectors as shown in FIG. 4B, accessible for connecting the modules 28 and 30 to the gaming unit 14 from outside the housing 18.

With reference again to FIG. 5, the removable plug-in processor module 28 includes a main processor 32 for running the gaming program, that is, executing logic instructions in a known manner, which enables the remote gaming unit to provide game play for the corresponding player. The main processor 32 is preferably an SA-1110 CPU made by Intel® Corporation of Santa Clara Calif., although alternatively, any suitable known processor can be used.

Other functions of the main processor can include controlling the operation of the gaming unit 14, and controlling the communications with other gaming units 14 and the master station 12 via the communications module 30. The remote electronic gaming unit 14 of the invention is therefore considered a dumb gaming unit because it does not have a resident main processor and is unable to function for game play until and unless the plug-in processor module 28 having the main processor 32 is connected to it.

The gaming unit 14 defining the invention may have one or more resident secondary or slave processors, such as the display controller 22a which are ultimately controlled by the removable main processor 32. The slave processors perform tertiary tasks but do not run the game play program.

The plug-in processor module 28 further includes memory such as RAM 34, ROM 36 and EPROM 38 connected to the main processor in a conventional manner. The ROM 36 can be flash ROM or any other suitable ROM. The processor module 28 may optionally include a battery 40, such as a coin cell battery or any other known battery, suitable for data memory backup to allow the module 28 to be transported separately from the remote game unit while maintaining information stored in the processor module 28.

Referring to FIGS. 5 and 6, the plug-in processor module 28 can also include an optional connector 42 for receiving a plug-in memory module 44, such as a flash compact card or a media card. The plug-in memory module 44 increases the memory available to the main processor 32, thereby enabling the remote gaming unit 14 to display additional information, such as video and audio presentations. The plug-in memory module 42 can be quickly and easily added to each processor module 28 to provide the latest presentation available specific to the particular gaming establishment where the gaming system 10 is used.

Referring to FIGS. 5 and 7, the plug-in communications module 30 is removably connected to the remote gaming unit 14 to provide a communications link between the remote gaming unit 14 and the master station 12, or other remote gaming units 14 in the logical network. The communications module 30 includes known radio communications hardware 46 and an antenna 47. The radio communications hardware 46 utilizes 802.11 protocols or any other suitable known protocols, such as Bluetooth.

The radio communications hardware 46 operates in conventional frequency bands with proper power outputs, and using the proper modulation techniques needed to meet the requirements of regulatory bodies of any specific location. Providing the radio communications hardware 46 in a plug-in module 30 removably connected to the remote gaming unit 14 enables the remote gaming unit 14 to be quickly and easily configured for use in any location, using any desired communications scheme, by plugging in the proper communications module 30 without requiring the redesign of the basic game unit.

The data bandwidth of the radio communications hardware 46 should be sufficient to allow real time downloading of not only gaming parameters, but also dynamic program changes and program upgrades over the RF link with minimal delay. Additionally, the bandwidth should be sufficient to support a large number of basic game units, on the order of 1,000 to 3,000 units, to enable effective communication in relatively short periods of time, such as the duration of time between bingo ball number calls, typically on the order of 5 to 15 seconds.

The radio communications hardware 46 includes spread spectrum technologies such as Direct Sequence, Frequency Hopping or any other suitable known technology to provide security and anti-jamming capabilities assuring the reliability of the information transmitted. Such transmission techniques inherently offer a very good level of security by spreading the data information over a large band of frequencies and by employing chipping or scrambling codes which are unique to the network. Additional known means of data encryption, such as DES or other similar schemes, can be implemented by the processor 32 to guarantee data security.

The processor module or remote gaming unit may also contain a theft deterrent device utilizing an RFID sold by WhereNet or other similar technology for tracking the location of the processor module on the gaming floor. Each module's unique ID address, and floor location can be graphically displayed on the master station to track the module movement.

Alternatively, the plug-in communications module 30 may include a known hard-wired communications connection 48, such as an Ethernet connection, or any other suitable hard-wired connection to allow the remote gaming unit 14 to communicate over a known Local Area Network (LAN) or Wide Area Network (WAN) including the internet. Alternatively, the communications module can be a phone line module or an infrared system. It could also employ the BLUETOOTH™ wireless communications protocol.

The processor module 28 is initially programmed in manufacturing in a known manner, such as with a boot loader communications program, via a cable or preferably, on a production In Circuit Tester (ICT) machine via a “bed of nails” fixture. Means may also be provided to allow downloading during manufacture or in a field environment, of the hardware configuration of the I/O board for the target product that the processor module will be plugged into. This may not be required if the processor module and I/O board utilize commonly known techniques to self identity the hardware configuration when the processor module is plugged in the I/O board. This operation is similar to what is currently referred to as “plug-n-play” found in most all new Windows based computers.

Once the main program has been loaded into the module 28, the module can utilize the communication methods to down load game specific information on a real time basis during and just prior to game execution or in a non-dynamic mode at the beginning of a game session, or between games. Examples of game specific information include, but are not limited to the card serial numbers in play, the “paper color” of the cards in play which identify the group of cards in play, wild card identifiers, win patterns, and win bonuses such as added jackpots.

The remote gaming unit 14 further includes one or more batteries 50, which can be any known types of batteries, including rechargeable or disposable batteries used for powering electronic devices. The batteries 50 can be housed in an optional removable battery pack which can be snapped into place in the gaming unit 14 and easily removed by authorized personnel when necessary.

Referring again to FIGS. 2 and 5, the remote gaming unit 14 can include a variety of optional I/O devices such as a laser scanner 52 for scanning a bar code representing a card number as a means of loading the card information into the remote gaming unit when the player purchases the card for game play. A scan button 53 can also be provided to selectively activate the scanner 52. The remote gaming unit 14 can also include a remote monitor output connector 54 to enable a separate monitor (not shown) to be connected to the gaming unit 14. The remote gaming unit can also include a serial port 56, and printer port 58 and a magnetic card reader or smart card reader for player tracking.

When a player believes he has scored a Bingo, he indicates such by calling “Bingo”. The remote gaming unit also includes a speaker 60 and microphone 62 to enable two-way voice communication via a known CODEC 64 with the master station 12 and other units connected to the logical network.

The remote gaming unit 14 can also include a false Bingo deterrent means 68, typically implemented by the gaming program. The false Bingo deterrent means 68 monitors whether the remote gaming unit 14 has actually scored a Bingo in a known manner. While a hardware block is illustrated, if the remote gaming unit 14 has scored a Bingo, the false Bingo deterrent means 68 enables communication between the microphone 62 and the other gaming unit speakers 16, 60, or just the master station speaker 16, so that the player's voice announcing the Bingo can be broadcast to the other players.

The speaker 16 is preferably a public address system connected to the master station 12 in a known manner for broadcasting the player's voice. Although, alternatively, the speaker 16 can be any other known speaker or speaker system.

The invention therefore provides a flexible gaming system by using remote gaming units combined with interchangeable communication, processor, and memory modules of various memory sizes and execution capabilities. The plug-in processor and memory modules centrally locate all core technology components, game related parameters, user information, financial transactions, and security methodologies which may need to be changed to meet the specific requirements of a particular location or customer.

The processor module and communication modules plug into a basic game unit containing customary I/O devices and user interfaces. The basic gaming unit 14 containing I/O devices 20 and associated circuitry can be easily re-packaged into many custom user and OEM configurations by simply replacing the processor module 28 and communications module 30 without the difficulty, time, and cost of developing new gaming unit printed circuit boards containing processor elements.

Thus, the electronic gaming system according to the present invention is provided with a master station connected to one or more electronic remote gaming units in a logical network. Each electronic remote gaming unit includes a connection interface for receiving a removable plug-in processor module and a removable plug-in communication module. The plug-in processor module includes a main processor for running a gaming program which enables the remote gaming unit to provide game play to a player. The main processor can also control the operation of the remote gaming unit and control communications with other gaming units via the communication module. The communication module includes wireless communications hardware or hard-wired communications hardware for communicating with the other gaming units in the logical network.

In accordance with a second aspect of the invention, the gaming system can include a false bingo deterrent means for inhibiting voice communication from the remote gaming unit to other gaming units, or just the master station, to prevent the broadcast of a false Bingo to the other players when the remote gaming unit has not scored a Bingo.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

What is claimed is:

1. An electronic gaming system for providing game play to a user, said electronic gaming system comprising:
a dumb electronic gaming unit requiring a processor for operation during game play, said dumb electronic gaming unit having at least one I/O device; and
a processor module removably connected to said dumb electronic gaming unit, said processor module including a processor for controlling the operation of said dumb electronic gaming unit and running a game play program during game play.

2. The electronic gaming system defined in claim 1 wherein said electronic gaming unit includes a housing having an externally exposed connector for connecting said processor module to said electronic gaming unit.

3. The electronic gaming system defined in claim 1 wherein said electronic gaming unit includes a housing having a bay for receiving said processor module and said bay includes a connector for connecting said processor module to said electronic gaming unit.

4. The electronic gaming system defined in claim 1 wherein said processor module includes a unique identifier.

5. The electronic gaming system defined in claim 4 wherein said unique identifier is an IP address.

6. The electronic gaming system defined in claim 1 further comprising a plug-in communication module electrically connected to said processor for communicating with another gaming unit in a logical network.

7. The electronic gaming system defined in claim 6 wherein said another gaming unit is a master gaming unit in a logical network.

8. The electronic gaming system defined in claim 6 wherein said plug-in communication module includes wireless communications hardware.

9. The electronic gaming system defined in claim 8 wherein said wireless communications hardware includes security means.

10. The electronic gaming system defined in claim 6 wherein said plug-in communication module includes hardwired network communications hardware.

11. The electronic gaming system defined in claim 10 wherein said hard-wired network communications hardware includes at least one of Ethernet connection hardware and a telephone line.

12. An electronic gaming system including a plurality of gaming units connected together in a logical network for providing game play to one or more players, said electronic gaming system comprising:
a remote electronic gaming unit for use by a player during game play, said remote electronic gaming unit comprising an output device, a connector and a processor module removably connected, via said connector, to said remote electronic gaming unit;
a plug-in communications module removably connected to said remote electronic gaming unit, said communications module including communications hardware for providing a communications link between said remote electronic gaming unit and another gaming unit in said logical network.

13. The electronic gaming system defined in claim 12 wherein said another gaming unit is a master gaming unit in said logical network.

14. The electronic gaming system defined in claim 12 wherein said another gaming unit is another remote gaming unit in said logical network.

15. The electronic gaming system defined in claim 12 wherein said plug-in communication module includes wireless communications hardware.

16. The electronic gaming system defined in claim 12 wherein said output device comprises a display.

17. The electronic gaming system defined in claim 12 wherein said plug-in communication module includes hardwired network communications hardware.

18. The electronic gaming system defined in claim 17 wherein said hard-wired network communications hardware includes at least one of Ethernet connection hardware and a telephone line.

19. The electronic gaming system defined in claim 12 wherein said remote gaming unit includes a housing in which said output device and said connector are disposed and further comprising an external connector, wherein said communications module is a plug-in module for connecting to said connector.

20. An electronic Bingo gaming system for providing game play to a user, said electronic Bingo gaming system comprising:
a master gaming unit;
a remote electronic gaming unit spaced apart from said master gaming unit, said remote electronic gaming unit having a microphone for providing voice communication with said master unit to indicate said remote electronic gaming unit has scored a Bingo; and
a speaker connected to said master unit for broadcasting said voice communication when said remote gaming unit has scored a Bingo.

21. The electronic bingo gaming system defined in claim 20 further including false Bingo deterrent means for defeating the broadcast of said voice communication when said remote gaming unit has not scored a Bingo.

22. An electronic gaming system for running an associated game play program capable of providing game play to a player, said electronic gaming system comprising:
a master unit;
a plurality of hand-held units spaced away from said master unit, each hand-held unit comprising:
a housing,
an I/O device held in said housing, and
a connector; and,
a plurality of plug-in processor modules, one for each of said plurality of hand-held units, each processor module comprising a connector adapted to mate with said connector of a respective one of said plurality of hand-held units, wherein each of said plurality of hand-held units cannot run the associated game play program without a respective one of said plurality of processor modules.

23. The electronic gaming system of claim 22 further comprising a plurality of plug-in communications modules selectively electrically connected to a respective one of said plurality of hand-held units to enable said plurality of hand-held units to communicate with said master unit.

24. The electronic gaming system of claim 23 wherein said master unit is stationary and said hand-held units are portable.

25. The electronic gaming system of claim 24 wherein said communications modules each include wireless communications hardware.

26. The electronic gaming system defined in claim 23 wherein said plurality of plug-in communications modules each include security means.

27. The electronic gaming system defined in claim 23 wherein each of said plug-in communications modules include hardwired network communications hardware.

28. The electronic gaming system defined in claim 23 wherein each of said plug-in communications modules includes at least one of Ethernet connection hardware and a telephone line.

29. The electronic gaming system of claim 22 wherein each of said plurality of handheld units further comprises a theft deterrent feature.

30. The electronic gaming system of claim 22 further comprising a battery connected to said housing for powering said I/O device.

31. The electronic gaming system defined in claim 22 further comprising a memory backup battery in each of said plurality of plug-in processor modules.
